(19) United States
(12) Patent Application Publication
(10) Pub. No.: US 2016/0054465 A1
(43) Pub. Date: Feb. 25, 2016

(54) SEISMIC DATA SPECTRUM RESTORING AND BROADENING

(71) Applicant: DOWNUNDER GEOSOLUTIONS PTY LTD, West Perth, Western Australia (AU)

(72) Inventors: Matthew Gordon LAMONT, Subiaco (AU); Stuart David MIDGLEY, Hamersley (AU); Michael Ian HARTLEY, Floreat (AU); Troy Alan THOMPSON, Doubleview (AU); Bjorn MULLER, Woodvale (AU)

(21) Appl. No.: 14/781,776

(22) PCT Filed: May 16, 2014
(86) PCT No.: PCT/AU2014/000525

§ 371 Date: Oct. 1, 2015

(30) Foreign Application Priority Data
Jun. 10, 2013 (AU) 2013902152

(51) Int. Cl. G01V 1/36; G01V 1/38

(52) U.S. Cl. CPC G01V 1/368; G01V 1/38; G01V 2210/56; G01V 2210/25

(57) ABSTRACT

A method of spectrum restoring and broadening to produce high resolution seismic data from a plurality of shot records in a seismic survey is described. The method includes the steps of: dividing each shot record into a plurality of windows, in which each of the relevant variables is practically constant, and wherein each window contains one or more trace segments; forward modelling of spectral signatures for any ghost reflections in the shot records using a best estimate of all known parameters, such that every trace segment will have an observed and a (prior) modelled spectral signature; calculating an inverse operator to correct the spectral notches in every trace segment using a constrained set of final fitted values for all the relevant variables; and, recombining the processed trace segments to produce a final set of shot records whereby, in use, the deleterious effects of the ghost reflections in the shot records can be substantially eliminated. Amplitude and phase errors, both within a single shot record and between shots, due to ghost reflections can be corrected.

### FIELD OF THE INVENTION

The present invention relates to a method of spectrum restoring and broadening to produce high-resolution seismic data obtained in geophysical exploration and relates particularly, though not exclusively, to seismic data obtained from offshore marine seismic surveying.

### BACKGROUND TO THE INVENTION

Geophysical exploration for and exploitation of subsurface hydrocarbon reserves relies on the use of seismic surveying. Seismic surveys can be acquired both onshore (land) and offshore (marine). In a marine seismic survey one or more streamers (a long cable containing receivers spaced regularly along its length) are towed behind a boat. A seismic source (typically an air gun array) is also towed directly behind the boat. This source creates an acoustic signal that propagates down through the water column and into the geological strata beneath. The signal is refracted and reflected off the various rock layers travelling back up where it is ultimately recorded by the receivers (or channels) in the streamer.

The seismic source is typically fired at regular intervals (called shots) as the boat travels forward. Each channel records the reflected signals as a function of time producing a single seismic trace. The collection of recorded traces from all channels along a single cable is called a shot record. The seismic survey is made up of many shot records along a single sail line or many parallel sail lines covering a large area. These raw (pre-stack) shot records must undergo sophisticated processing in order to create a final (post-stack) seismic volume for interpretation of geophysical characteristics.

The aim of seismic surveying is to record the response of the earth to seismic (acoustic) signals. As the need to characterise thinner and more complex hydrocarbon reservoirs increases so too does the demand for high-resolution seismic data. Resolution of course, is a function of bandwidth, or the range of frequencies that are present in the data. Broader bandwidth (i.e. more useable frequencies that represent reflected signals from the earth), in particular at the lower frequency end, is now in high demand. Many aspects related to the acquisition and the physics of the propagating acoustic signals act to limit the bandwidth that can be recorded.

A well-known issue in marine acquisition relates to reflections from the sea surface (air/water interface). Acoustic signals travelling upwards in the water layer will be reflected (with opposite polarity) from this interface. These are termed ghost reflections. The receivers in the streamer, record not only the desired (single reflection up-going) wave field but also these down-going reflections from the sea surface. These ghost reflections destructively interfere with the primary reflection of interest resulting in notches (at particular frequencies). These notches limit the useable bandwidth of the data and are thus undesirable.

The location of the notches depends on a number of variables, in particular the source and receiver depths but also the water bottom depth, two way reflection travel time, sea state, angle of incidence (obliquity), signal to noise ratio and receiver offset (or distance from the source). Variations in all of these parameters mean that the location (and severity) of spectral notches can vary considerably in each (of the four) pre-stack data dimensions (X, Y, time, channel). This is often termed notch diversity. The ghost reflections distort both the amplitude and phase of the data. Diversity in the notches means that the phase and amplitude distortion varies both within a single shot record and between shots. Reservoir characterization requires pre-stack data with consistent and compliant amplitude and phase characteristics.

The problem associated with ghost reflections has been known for many decades and there have been a variety of proposed solutions over the years. Many acquisition-based solutions were published in the 1980s and 1990s; however these were operationally inefficient and unreliable. To avoid notches in the seismic bandwidth conventional towed-streamer acquisition uses shallow source and receiver depths. For example a cable towed at six metres depth will have its first non-zero notch at 125 Hz, which is typically higher than the seismic signal bandwidth. Shallow streamers unfortunately have a number of disadvantages, as the very high and very low frequencies are adversely affected resulting in a reduction of bandwidth. Shallow cables are also subject to more environmental noise (such as swell noise). Quiet, (low mechanical noise from the actual streamer receiver system itself) deep-tow cables are preferred to record a broader bandwidth with more valuable very low frequency content. However, having a deeper cable means that the non-zero notches do appear within the seismic bandwidth. Solutions to the ghost problem have tended to revolve around two main approaches:
(a) Improvements in acquisition technology; and
(b) Improvements in data processing techniques.

Recent improvements in acquisition technology over the last six or so years have attempted to address the issue more directly. These include over-under streamers (Grion et al., 2001; Hill et al., 2006; Moldoveanu et al., 2007; Ozdemir et al., 2008), variable depth/slant streamer (Soubaras, 2013) and dual sensor (Carlson et al., 2007; Tenghamn et al., 2007; Parks and Hegna, 2011a,b).

However, the fact remains that the majority of new and existing data have been recorded with conventional streamers and have bandwidth limitations as a result of destructive interference from free surface ghost reflections (ghosts). Consequently, processing based solutions which remove the distortion caused by the ghosts are required. Various approaches have been proposed in the past, which include tau-p transforms (Krail and Shin, 1990), f-k transforms (Aytun, 1999) and Weiner-Levinson type deconvolutions (Ghosh, 2000; Zhou et al., 2012; Ziolkowski, 2012). Each of these approaches has limiting assumptions that make them less appropriate in certain situations.

It is tempting to consider using tau-p or fk spaces for notch correcting filter design and application; tau-p appears to be a perfect space for this application. However, utilising tau-p space ignores the receiver depth variations that have a profound effect on notch locations. As soon as the tau-p transform is applied the notch locations are mixed forever. This may at first seem like a good thing as notch diversity, due to receiver depth changes along the cable, means that after the stacking inherent in the tau-p transform, notches will appear to be much reduced. However, amplitude issues due to the notch diversity will remain, not to mention the phase being completely mixed and no longer correctable. In other words as soon as a tau-p transform is applied, it is impossible to recover some of the lost information. Utilising an fk transform isn't advantageous either because the localisation in time is also lost.

The Weiner-Levinson type deconvolution operators also suffer from a number of limiting assumptions. Indeed some of the assumptions are completely in opposition to the amplitude and phase distortion caused by ghost reflection interference:
Minimum phase wavelet: The phase distortion caused by the ghost reflection means that the embedded seismic wavelet is not minimum phase.
Stationary wavelet: Notch diversity means that the embedded seismic wavelet varies both within and between shot records.
Noise free data: Noise is unavoidable and variable both within and between field shot records.
White reflectivity spectrum: Seismic data is band-limited and the amplitude distortion caused by the ghost reflections mean this observed spectrum is certainly not white. Using large windows to help overcome this only serves to further break the previous three assumptions.

Accordingly, the present invention was developed with a view to providing a method of spectrum restoring and broadening to produce high resolution seismic data in which the deleterious effects of ghost reflections can be substantially eliminated. While the following description will assume a marine setting the method is no less applicable to land acquisition of seismic data.

References to prior art in this specification are provided for illustrative purposes only and are not to be taken as an admission that such prior art is part of the common general knowledge in Australia or elsewhere.

### SUMMARY OF THE INVENTION

According to one aspect of the present invention there is provided a method of spectrum restoring and broadening to produce high resolution seismic data from a plurality of shot records in a seismic survey, the method comprising the steps of:

dividing each shot record into a plurality of windows, in which each of the relevant variables is practically constant, and wherein each window contains one or more trace segments;

forward modelling of spectral signatures for any ghost reflections in the shot records using a best estimate of all known parameters, such that every trace segment will have an observed and a (prior) modelled spectral signature;

calculating an inverse operator to correct the spectral notches in every trace segment using a constrained set of final fitted values for all the relevant variables; and,

recombining the processed trace segments to produce a final set of shot records whereby, in use, the deleterious effects of the ghost reflections in the shot records can be substantially eliminated.

Preferably, following the step of dividing each shot record, the method further comprises the step of ray-tracing through a velocity model (if available) to obtain the travel times of the ghost reflections for calculating a prior spectral signature. Preferably a three-dimensional velocity model is employed and the respective ray paths are traced in three dimensions from source to receiver through the model in order to calculate the travel times for each ghost reflection.

Preferably, following the step dividing each shot record, the method further comprises the step of carefully selecting windows with consistent (with respect to the variables influencing the position of any ghost reflections) trace segments of data and stacking the selected windows to produce an observed spectral signature.

Preferably an optimisation is performed to match the modelled to the observed signatures and in so doing the parameter choices in every window are refined.

Typically the step of forward modelling of spectral signatures for the ghost reflections involves adding the effects of polarity changes, attenuations and time lags introduced by the ghost reflections to the primary reflection. Preferably the polarity changes, attenuations and time lags introduced by the ghost reflections are modelled as a complex frequency-dependent gain function. Preferably the total complex gain, for a given frequency f is modelled as

G(f)=1−Rfc_{surf}e^{2πifΔt}^{_{sg}}−Rfc_{surf}e^{2πifΔt}^{_{rg}}+Rfc_{surf}²e^{2πifΔt}^{_{2g}}

where Rfc_{surf} is the modelled sea surface reflectivity (positive), and Δt_{sg}, Δt_{rg} and Δt_{2g} are the time lags between the primary reflection and the source, receiver and double ghost reflections respectively. That is,

Δt_{sg}=t(_{sg})−t

Δt_{rg}=t(_{rg})−t

Δt_{2g}=t(_{2g})−t

Preferably each shot record is divided into a plurality of windows using a radial trace architecture. Preferably the step of dividing each shot record into a plurality of windows using a radial trace architecture involves limiting the span of the design windows to deliver localisation in receiver depth, in incident angle, in Two Way Time (TWT), and localisation in source depth and sea state by having each window span shot records that are most similar in source depth and receiver depth. Preferably all shots within the survey are initially binned into groups based on these parameters to ensure localisation of parameters between shots in the windows.

Typically the radial trace architecture can be used in two different ways, both of which produce substantially the same outcome. In one method a full radial trace transform may be applied whereby the shot record (TWT vs offset) is remapped onto radial traces (TWT vs angle). Alternatively design windows may be constructed from trace segments that form a patch along radial trace trajectories.

Preferably following optimisation a set of fitted parameters exist for every trace segment, which can then be used to design an inverse filter to correct the distortion caused by the ghost reflections. Preferably these fitted parameters are then further constrained with respect to the expected variability both within a shot and between shots. Typically an inverse filter is achieved by correcting the amplitudes and phases separately.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of several specific embodiments of the method of seismic data spectrum restoring and broadening, given by way of example only, with reference to the accompanying drawings, in which:

FIG. 1 illustrates schematically how the travel time (from source to receiver) of a seismic signal can be calculated;

FIG. 2 illustrates schematically the ray paths of the primary reflection and three types of ghost reflections;

FIG. 3 illustrates schematically a preferred embodiment of a radial trace trajectory windowing model employed in the method of the invention;

FIG. 4 shows examples of the gain function employed in a preferred method of the invention before and after an optimization process; and,

FIG. 5 illustrates the sequence of steps in a preferred method of processing trace segments according to the method of the invention.

### DETAILED DESCRIPTION OF PREFERRED EMBODIMENTS

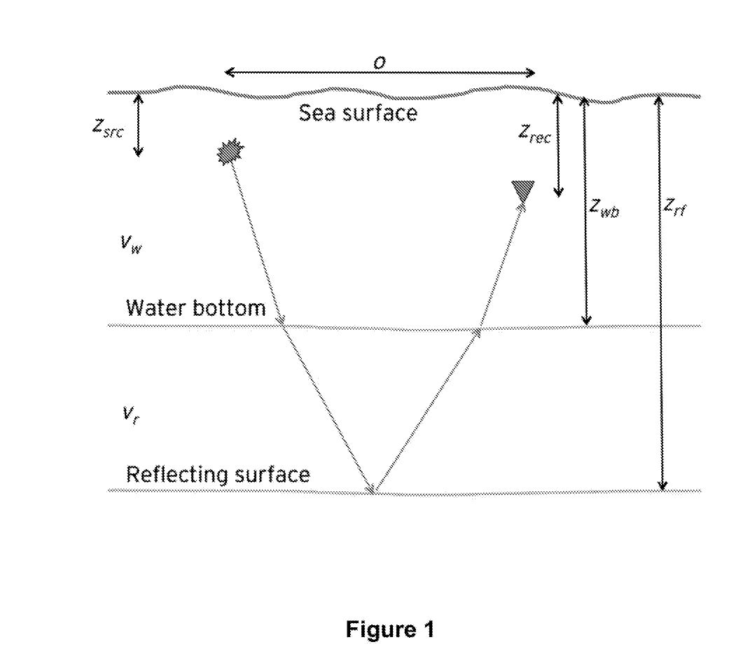

A seismic signal passes from a source through the water, refracts through the water bottom, reflects off a reflector within the rock (or any strata), refracts back out through the water bottom, and eventually reaches a receiver, where it is recorded. The travel time (t,) can be computed from the source (z_{src},) and receiver (z_{rec}) depths, the water bottom depth (z_{wb}) and the depth of the reflector (z_{rf,}), the velocity in water (v_{w}) and in rock (vᵣ), and the offset (o) (horizontal distance) between receiver and source (FIG. 1). In fact, any one of these quantities (t, z_{src}, z_{rec}, z_{wb}, z_{rf}, v_{w}, vᵣ and o) may be computed from the others. Geophysical constraints enable a reasonable initial value of vᵣ to be selected prior to optimization. They are linked by the equations

$$\frac{{o}_{w}}{{d}_{w}} \frac{{v}_{r}}{{v}_{w}} = \frac{{o}_{r}}{{d}_{r}}$$

$${d}_{w} = \sqrt{{o}_{w}^{2} + {( 2 {z}_{wb} - {z}_{arc} - {z}_{rec} )}^{2}}$$

$${d}_{r} = \sqrt{{o}_{r}^{2} + {( 2 {z}_{rf} - 2 {z}_{wb} )}^{2}}$$

$${o}_{w} + {o}_{r} = o$$

$$t = {t}_{w} + {t}_{r}$$

$${t}_{w} = \frac{{d}_{w}}{{v}_{w}}$$

$${t}_{r} = \frac{{d}_{r}}{{v}_{r}}$$

Here, o_{w} and oᵣ are respectively the horizontal (offset) distance traversed while in water and rock. Similarly, d_{w} and dᵣ are the total distance traversed in the water or rock, and t_{w} and tᵣ are the times spent there.

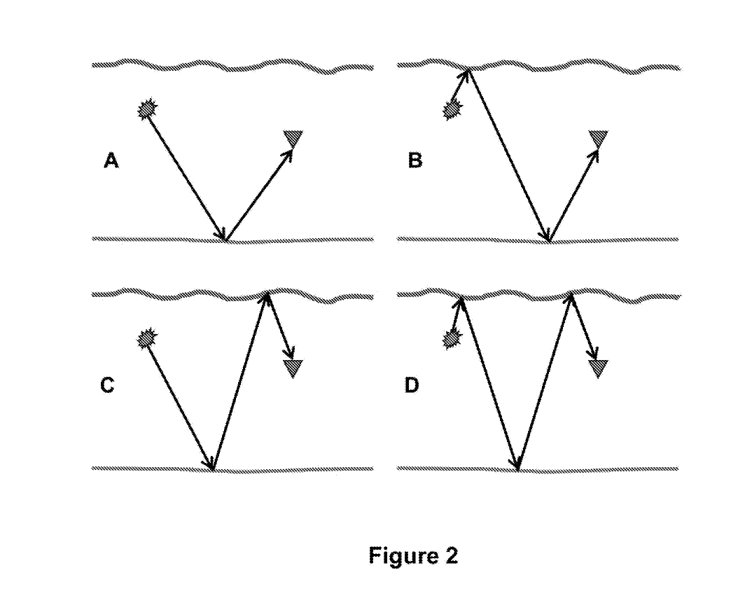

As illustrated in FIG. 2, ghost reflections that have reflected off the water surface near the source, near the receiver, or both, will arrive at the receiver after (a time lag) the primary reflection of interest (ray A in FIG. 2). There are two types of ghost reflection, commonly referred to as the source ghost and receiver ghost. The source ghost (ray B in FIG. 2) travels upward directly from the source, is reflected at the sea surface and then goes on to be reflected off the rock strata and recorded. The receiver ghost (ray C in FIG. 2) travels upward after being reflected of the rock strata and is reflected of the sea surface before being recorded.

There is a third ghost reflection (D in FIG. 2) that reflects of the sea surface twice before being recorded. It is a combination of the source and receiver ghosts previously mentioned. This “double ghost” travels upward directly from the source, is reflected at the sea surface, travels down were it is reflected of the rock strata, travels up and is reflected again off the sea surface before being recorded by the receiver. The travel time for the source ghost ray (the one that reflects off the surface near the source, but not the receiver) will be given by a set of equations similar to those above, with the equation for d_{w} replaced by:

d_{w}^{(sg)}=\sqrt{o_{w}²+(2z_{wb}+z_{src}−z_{rec})²}

We can also form equations for the receiver ghost and double ghost travel times, using:

d_{w}^{(rg)}=\sqrt{o_{w}²+(2z_{wb}−z_{src}+z_{rec})²}, and

d_{w}^{(2g)}=\sqrt{o_{w}²+(2z_{wb}+z_{src}+z_{rec})²}

The computed travel times for the source, receiver and double ghost reflected ray paths being t^{(sg)}, t^{(rg)} and t^{(2g)}, respectively.

When a more detailed velocity model of the subsurface is available the travel times for the source, receiver and double ghost reflected ray paths can be determined more accurately via ray-tracing. The velocity model can be one-, two- or three-dimensional. Typically a three-dimensional velocity model is preferred and the respective ray paths are traced in three dimensions from source to receiver through the model in order to calculate the travel times for each ghost.

The location of the notches caused by ghost reflections depends on a number of variables, as noted above. Variations in all of these parameters mean that the location (and severity) of spectral notches can vary considerably in each of the pre-stack data dimensions (X, Y, time, channel). This is referred to as notch diversity. The reality of notch diversity is preferably dealt with in the pre-stack domain. Notches are diverse in pre-stack space, consequently this approach can be adopted. However it is critical for quantitative amplitude studies that the adverse effects of the source and receiver ghosts with respect to both amplitude and phase be dealt with before stacking takes place.

According to the preferred method of the invention, following initial pre-processing (transcription/navigation-merge/gain/swell noise removal etc.) the spectral signatures (including the source and receiver ghosts) are forward modelled using the best estimate of all known parameters. These signatures can be thought of as gain functions. The gain functions describe the distortion imposed on the recorded seismic spectrum due to the ghosts. The gain functions are preferably modelled in windows where each of the relevant variables is practically constant. Modelling of the gain functions will be described in more detail below.

Advantageously each shot record is divided up into a plurality of windows using radial trace architecture. Observed spectra from windows, (within and across shots) with common values for the variables affecting the notch locations, are stacked to increase the signal to noise ratio of the observed signatures and stabilize the inverse operator derivation. The normal moveout of the water bottom reflection is used to hang the shallowest windows, while at the same time ensuring that the water bottom reflection is captured within the shallowest window. Every window will then have an observed and a (prior) modelled signature. The radial trace architecture will be described in more detail below.

An optimisation is then performed to match the modelled to the observed signature and in so doing refine the parameter choices in every window. The parameters are geophysically constrained to ensure the fitted values adhere to the expected uncertainty in the known values as well as expected trends as a function of offset, time and radial trace trajectory (for example the source depth should be constant for any one shot and noise generally increases with increasing time). Following the optimisation, a constrained set of final fitted values for all the relevant variables can be used to calculate an inverse operator to correct the spectral notches in every respective trace segment. Optimisation and calculation of an inverse operator will be described in more detail below.

Importantly, this method corrects both the amplitude and phase of the seismic data. All of the processed trace segments are then recombined to produce the final set of shot records. Tapered and overlapping design windows are also utilised to ensure that parameter variations are geophysically constrained. This process removes the adverse effects of the ghosts, correcting both amplitude and phase while simultaneously accounting for and removing the notch diversity.

Radial Trace Architecture

The reality of notch diversity means that the embedded seismic wavelet changes continuously throughout a shot record and between shot records. On top of that, the Signal to Noise Ratio (SNR) also changes continuously. This is because receiver depths, incidence angles (obliquity), and SNR change within a shot record. Source depth and sea state change between shot records. The receiver depth of a given channel may also change between shots. In order to design stable inverse operators that can correct the distortion from ghosts it is desirable to remain as local as possible in all of these parameters. That is, any window must be designed to have the smallest range in variability of these parameters within it. None of these parameters can be ignored otherwise the filters will not be as optimal as possible, at best, or the optimisation used to design the filters won't converge to an appropriate solution at worst.

As mentioned, it is tempting to consider using tau-p or fk spaces for the notch correcting filter design and application. However after application of the tau-p transform it is impossible to recover some of the lost information. An fk transform is even worse because localisation in time is also lost. As previously noted, Weiner-Levinson type deconvolution operators also suffer from a number of limiting assumptions.

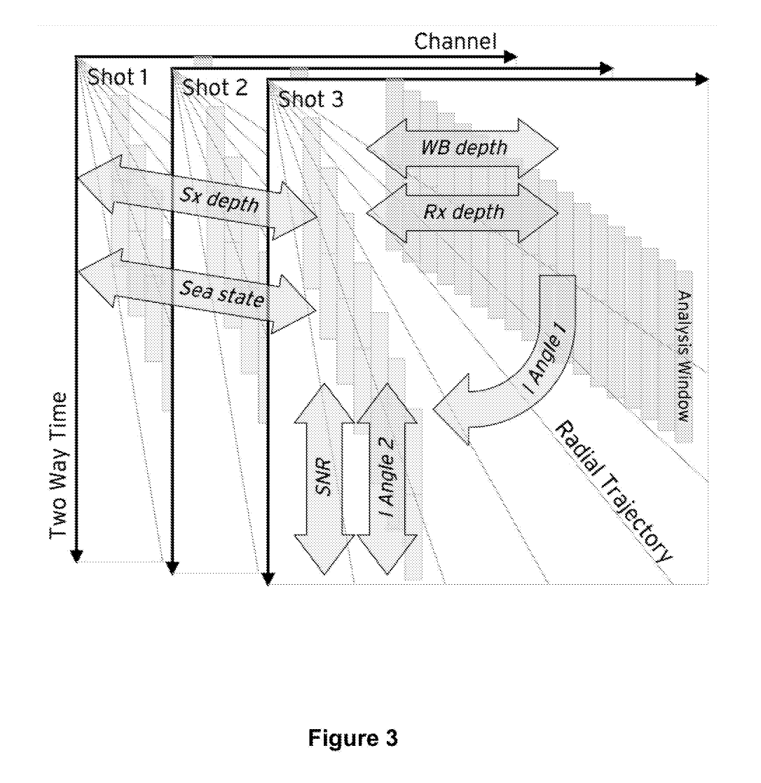

An overlooked transform or construct is the radial trace transform. It delivers the same localisation in incident angles as the tau-p transform (Lamont, 1998) but without sacrificing localisation in receiver depth or Two Way Time (TWT). Hence it is indeed the ideal way to achieve the needed localisation (as illustrated in FIG. 3):
Localisation in receiver depth as the design window has limited receiver span;
Localisation in incident angle as the design window has limited span in incident angle; and
Localisation in TWT as the design window has limited span in TWT.
   Thereby achieving:
Localisation in source depth and sea state by having the design window span shot records that are most similar in source depth and receiver depth.

FIG. 3 illustrates a preferred radial trace trajectory windowing model employed in the method of the invention for handling the various parameter variations controlling notch diversity, both within a single shot record and between shots. All shots within the survey are initially binned into groups based on these parameters to ensure localisation of parameters between shots in the windows. Each analysis window typically represents a single trace segment.
Sx=Source.
Rx=Receiver.
SNR=Signal-to-noise ratio.
WB=Water bottom.
I Angle 1=Angle of incidence 1: along any particular radial trajectory the angle of incidence is approximately constant.
I Angle 2=Angle of incidence 2: as two way time increases down the trace (a single channel) the angle of incidence will change due to variations in the rock velocity (vᵣ).

The radial construct can be used in two different ways, both of which produce substantially the same outcome. A full radial trace transform can be applied whereby the shot record (TWT vs offset) is remapped onto radial traces (TWT vs angle). Alternatively design windows can be constructed from trace segments that form a patch along radial trace trajectories.

Frequency Distortion Due to Ghosts

The polarity changes, attenuations and time lags of the ghost reflections can be modelled as a complex frequency-dependent gain function. As these rays interfere with the primary reflected ray at the receiver, these complex gains add. The total complex gain, for a given frequency f, is modelled as

G(f)=1−Rfc_{surf}e^{2πifΔt}^{_{sg}}−Rfc_{surf}e^{2πifΔt}^{_{rg}}+Rfc_{surf}²e^{2πifΔt}^{_{2g}}

where Rfc_{surf} is the modeled sea surface reflectivity (positive), and Δt_{sg}, Δt_{rg} and Δt_{2g} are the time lags between the primary reflection and the source, receiver and double ghost reflections respectively. That is,

Δt_{sg}=t(_{sg})−t

Δt_{rg}=t(_{rg})−t

Δt_{2g}=t(_{2g})−t

Finding a Suitable Inverse Filter

Given values of all these parameters, a filter to correct the distortion caused by the ghost reflections can be designed. In practice this is achieved by correcting the amplitudes and phases separately.

To correct the amplitudes of the seismic trace:
1. Reverse the trace and append it to itself.
2. Find the Fourier transform.
3. Multiply the Fourier transform by max(|G(f)|⁻¹, gₘₐₓ) where gₘₐₓ is the maximum (real) gain to apply to any frequency.
4. Find the inverse Fourier transform.
5. Clip the new trace to its original extents.

The amplitude correction is constrained (by step 3 above) such that corrections cannot be larger than a factor of ten.

To correct the phase of the seismic trace:
1. Pad the seismic trace at the start and end with zeroes, to double its length.
2. Find the Fourier transform.
3. Multiply the Fourier transform by G(f)*I|G(f)|.
4. Find the inverse Fourier transform.
5. Clip the new trace to its original extents.

For a given trace segment of seismic data, we typically know the quantities t, z_{src}, z_{rec}, z_{wb}, v_{w} and o mentioned earlier. Without a velocity model of the subsurface we don't know vᵣ but we know what is geologically reasonable. Nor do we know z_{src} and z_{rec} precisely enough to construct an inverse filter—even moderately small variations in these quantities can strongly influence the frequencies at which notches occur (that is, the frequencies at which ghost signals destructively interfere with the original signal). Moreover, the sea surface reflectivity is unknown with any degree of precision. In fact the sea surface reflectivity parameter also serves as a proxy for signal-to-noise-ratio (SNR). Hence, an optimization to identify/refine these four parameters is performed.

Following the optimisation a set of fitted parameters (which can be used to calculate an inverse filter) now exist for every trace segment. These fitted parameters are then further constrained with respect to the expected variability both within a shot and between shots as described below.

1. Source depth: For any given shot record the source depth should be a constant. To obtain a single optimal estimate for the source depth a median mean filter is applied to the top 1500 ms of data beneath the water bottom using only the first half of the channels for each shot. A running average of three shots is then used to get the final source depth for the centre shot.

2. Receiver depth: Receiver depth should be constant down any given channel (single trace within a shot record). We perform a median mean filter on all the fitted values in the top 1500 ms below the water bottom on each channel. A running average of three shots is then used to get the final receiver depths for each channel for the centre shot.

3. Rock velocity: Rock velocity is calculated from the optimized index of refraction variable. Rock velocity should be varying very smoothly along the radial trace trajectories. A rolling median mean filter is performed along the radial trajectories using a maximum of 35 trace segments. A moving average across three shots and three different radial trace trajectories (within a shot) respectively is then used to get the final values for the centre shot.

4. Sea surface reflectivity: As this is also a proxy for SNR this parameter will vary smoothly in all directions within a shot record—generally decreasing (ie lower SNR) with increasing time. A two-dimensional (2D) median-mean filter (15 traces by 3 design windows) is applied to each shot record is used to create the final values of Rfc_{surf}. The phase and amplitude corrections are treated differently with respect to this parameter in order to decouple the SNR and pure sea surface reflectivity effects. The inverse filter for the amplitude correction uses the smooth values of Rfc_{surf} after the 2D median-mean filter. The inverse filter for the phase correction uses a constant value of Rfc_{surf} for each channel obtained by averaging the first two windows (after the median mean filtering) beneath the water bottom.

It should be noted (and as defined previously) that the total complex gain function is a function of the modelled sea surface reflectivity and the time lags between the primary reflection and the source, receiver and double ghost reflections respectively. When a velocity model is available and ray-tracing is used to get the travel times of the ghost reflections then one can optimise directly on these quantities (namely Rfc_{surf}, Δt_{sg}, Δt_{rg} and Δt_{2g}). Post optimisation the variability within any given shot can be ensured to meet the smoothness criteria as described above.

Conjugate Gradient Optimisation

The theoretical amplitude gain |G(f)| at any given frequency may be considered a function g(f, z_{src}, z_{rec}, ior, Rfc_{surf}) of the four parameters z_{src} (source depth), z_{rec} (receiver depth), ior (index of refraction, vᵣ/v_{w}) and the sea surface reflectivity Rfc_{surf} (or g(f, Δt_{sg}, Δt_{rg}, Δt_{2g}, Rfc_{surf}) for the case when a velocity model is available and the lag times of the ghosts are determined via ray-tracing). If there is an estimated amplitude gain function g^{(est)}(f) obtained from seismic data, we can try to match g to g(est) by modifying the parameters. We do this by minimising:

$$error = {\sum }_{f ∈ F} w ( f ) {( log ( g ( f ) ) - log ( {g}^{( est )} ( f ) ) )}^{2}$$

where F is a set of sample frequencies of interest and w(f) is a frequency-dependent weighting function. Note that this error is a differentiable function of the four parameters z_{src}, z_{rec}, ior and Rfc_{surf}. The fact that derivatives can be computed allows the error to be minimised using techniques such as the conjugate gradient method. In practice, we actually minimise:

$$error = {\sum }_{f ∈ F} w ( f ) {( g ( f ) - {g}^{( est )} ( f ) )}^{2} + {{s}_{{z}_{rec}} ( {z}_{rec} - {z}_{rec}^{( given )} )}^{2} + {{s}_{{z}_{src}} ( {z}_{src} - {z}_{src}^{( given )} )}^{2} + {{s}_{ior} ( ior - {ior}^{( given )} )}^{2}$$

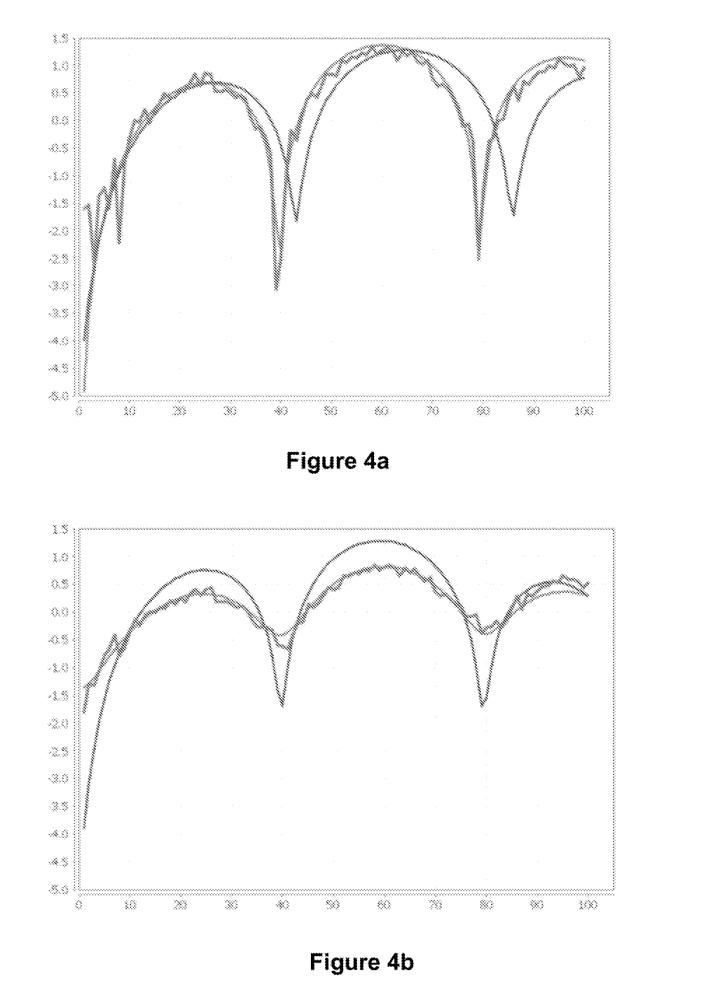

The addition of these extra terms allows us to constrain z_{rec}, z_{src} and ior (or alternatively Δt_{sg}, Δt_{rg} and Δt_{2g}). In effect, with these terms, the optimisation will not allow the final fitted values of these parameters to deviate too far from the given values. This is useful and necessary because while the source and receiver depths are known apriori, they do have some uncertainty and do vary across the survey (for example receiver depths are typically known to within one-meter accuracy). Adding these constraints is equivalent to imposing a Gaussian probability distribution on z_{rec}, z_{src}, ior and g(f), and computing the maximum likelihood estimate for the parameters. The variances of the Gaussian distributions would be proportional, respectively, to 1/sz_{rec}, 1/sz_{src}, 1/sior and 1/w(f). Some example results before and after the optimization is shown in FIG. 4.

The smooth curve in FIG. 4 is the initial modelled (amplitude) gain function using the apriori values of the acquisition parameters (source and receiver depth) as recorded during the seismic survey and estimated values for the sea surface reflectivity and index of refraction. These values have an inherent uncertainty and need to be refined to match the actual recorded data. The staggered curve in FIG. 4 is the observed gain function as measured from the seismic data. The second smooth curve is the modelled gain function after the optimisation, and now matches the staggered curve and can be used to design an optimal inverse filter.

The Weight Function

The weight function w(f) is somewhat complicated. It may be considered the product of three separate weight functions, namely:

w(f)=wₚ(f) [symbol] wₛ(f) [symbol] wₙ(f)

The first of these, wₚ(f), is determined by parameters passed in to the optimisation routine. Specifically, the user identifies a minimum and maximum frequency over which the fit is to take place. wₚ(f) equals 1 for f well inside this range, 0 for f well outside. Near the minimum and maximum frequencies, wₚ(f) ramps slowly up from 0 to 1 as f moves from the outside of the interval to the inside with wₚ(fₘᵢₙ)=wₚ(fₘₐₓ)=0.5.

The second component of the weight function is spectrum dependent. In fact, wₛ(f) is a normalised, highly smoothed version of the spectrum of the data to be corrected.

The final component, wₙ(f) is computed to give extra emphasis to errors near the notches. The formula for wₙ(f) is:

$${w}_{n} ( f ) = \frac{v}{{g ( f )}^{2} + K}$$

wherein K is some small positive number to ensure the weights do not become infinite, and v is a normalisation factor that ensures Σw(f)=1. Note that wₙ(f), and therefore w(f) depend on g(f), the function we are trying to find by optimisation. This naturally makes the derivatives of the error with respect to the parameters more complicated to work out, but not impossibly so. The conjugate gradient method can still be used.

Estimating the Gain Function from Seismic Data

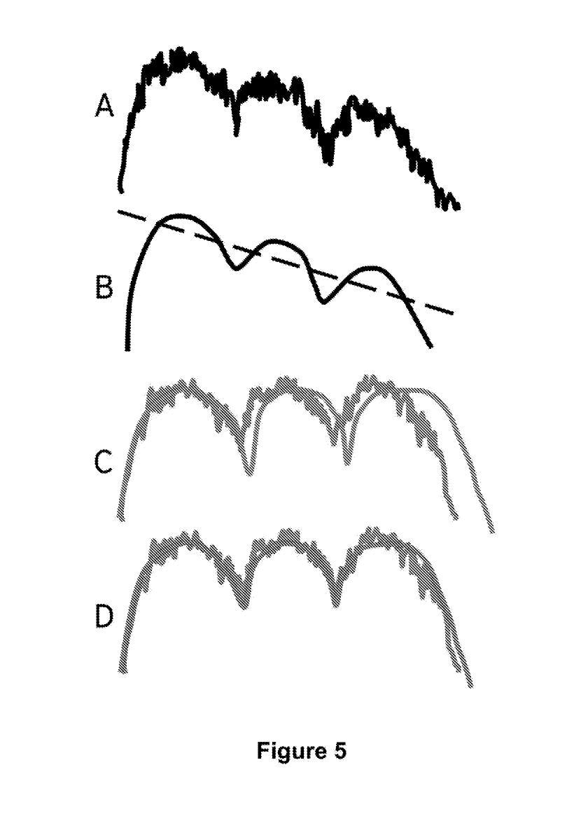

Before we can fit a gain function g(f) (and therefore G(f)), we need to compute an estimated gain function g^{(est)}(f) using a design window from the input seismic data. To estimate the gain function from the seismic data, we perform the following steps, as illustrated in FIG. 5:

(A) Radial trace windows of consistent (with respect to the variables influencing the position of the ghosts) trace segments of data are carefully selected and stacked to produce an observed seismic spectrum. In this way we obtain the averaged amplitude spectrum of the data from localised design windows (trace segments) of interest, based on the radial trace construct discussed in the previous section This spectrum will have some arbitrary amplitude, (shown in FIG. 5 on logarithmic scale) and bandwidth characteristics as defined by the particular data set in question. This means that in this form it cannot be directly compared to a theoretical gain function and must therefore be normalized. We take the log of this spectrum.

(B) The log spectrum from A is smoothed with a 7 Hz radius Gaussian smoother. We then fit a line (dashed black) to this smoothed log spectrum, using simple weighted linear regression and weight function wₚ(f). This yields a power-law fit to the original smoothed spectrum. We then divide the spectrum shown in A by this line to produce an unsmoothed estimated gain function. We smooth the log of this with a one-sample rectangular smoother, to obtain the estimated amplitude gain shown by the red curve (staggered line) (g^{(est)}(f)) in C.

(C) The initial modelled gain function g(f) is shown in blue (smooth line) and the estimated gain function from the data is shown in red (staggered line). An optimization is run to match the blue curve to the red curve to produce the final green curve G(f) (smooth line of (D)). The green curve is then used to design an inverse filter to correct both the phase and amplitude distortion caused by the ghosts.

One might expect that, since we can estimate a gain g^{(est)}(f) from the data, that we don't need to fit a theoretical gain function—that instead, g^{(est)}(f) could be used directly to construct an inverse filter. There are several reasons why this is not the case.

1. First of all, g^{(est)}(f) is not sufficiently smooth to be used directly in this way.

2. Smoothing g^{(est)}(f) tends to reduce the depth of the notches; so using an aggressively smoothed g^{(est)}(f) will leave notches in the input seismic data.

3. In any case, g^{(est)}(f) is just an estimate of the amplitude |G(f)| of the true gain. It cannot be used to correct the phase of the seismic data.

Following the removal of the diverse range of notches the data can then be further processed. This would include the usual zero phasing and the above described approach to spectral broadening (and balancing)—also critical for quantitative inversion studies. Both the low and high ends can be shaped to enhance those frequencies present, in an AVA friendly manner. Again, the spatial coherence of single frequency phase can be used to interpret the presence of source-generated signal. This ensures that only frequencies that contain signal are appropriately boosted during the spectral broadening phase.

The preferred method of the invention can produce data with significantly more octaves of usable bandwidth by correctly handling both amplitude and phase variations resulting from source and receiver ghosts (including a radial trace construct to handle notch diversity within and between shots) in the pre-stack domain. Recovering both high and low frequency information and restoring a broad and balanced spectrum have significant advantages from general interpretation through to quantitative inversion projects.

Now that preferred embodiments of the method of seismic data spectrum restoring and broadening has been described in detail, it will be apparent that the described embodiments provide a number of advantages over the prior art, including the following:
a) Seismic data from cables towed at any depth, including deep tow data can be processed.
b) Both amplitude and phase errors due to ghost reflections are corrected.
c) Uncertainty in source and receiver depths and positions can be accommodated.
d) Varying signal to noise ratio, sea state and water depth can be accounted for using the window modelling.
e) Pre-stack notch diversity is successfully removed.

It will be readily apparent to persons skilled in the relevant arts that various modifications and improvements may be made to the foregoing embodiments, in addition to those already described, without departing from the basic inventive concepts of the present invention. Therefore, it will be appreciated that the scope of the invention is not limited to the specific embodiments described.

1. A method of spectrum restoring and broadening to produce high resolution seismic data from a plurality of shot records in a seismic survey, the method comprising the steps of:
dividing each shot record into a plurality of windows, in which each of the relevant variables is practically constant, and wherein each window contains one or more trace segments;
forward modelling of spectral signatures for any ghost reflections in the shot records using a best estimate of all known parameters, such that every trace segment will have an observed and a (prior) modelled spectral signature;
calculating an inverse operator to correct the spectral notches in every trace segment using a constrained set of final fitted values for all the relevant variables; and,
recombining the processed trace segments to produce a final set of shot records whereby, in use, the deleterious effects of the ghost reflections in the shot records can be substantially eliminated.

2. A method of spectrum restoring and broadening as defined in claim 1, wherein following the step of dividing each shot record, the method further comprises the step of ray-tracing through a velocity model (if available) to obtain the travel times of the ghost reflections for calculating a prior spectral signature.

3. A method of spectrum restoring and broadening as defined in claim 2, wherein a three-dimensional velocity model is employed and the respective ray paths are traced in three dimensions from source to receiver through the model in order to calculate the travel times for each ghost reflection.

4. A method of spectrum restoring and broadening as defined in claim 1, wherein following the step of dividing each shot record, the method further comprises the step of carefully selecting windows with consistent (with respect to the variables influencing the position of any ghost reflections) trace segments of data and stacking the selected windows to produce an observed spectral signature.

5. A method of spectrum restoring and broadening as defined in claim 1, wherein an optimisation is performed to match the modelled to the observed signatures and in so doing the parameter choices in every window are refined.

6. A method of spectrum restoring and broadening as defined in claim 1, wherein the step of forward modelling of spectral signatures for the ghost reflections involves adding the effects of polarity changes, attenuations and time lags introduced by the ghost reflections to the primary reflection.

7. A method of spectrum restoring and broadening as defined in claim 6, wherein the polarity changes, attenuations and time lags introduced by the ghost reflections are modelled as a complex frequency-dependent gain function.

8. A method of spectrum restoring and broadening as defined in claim 7, wherein the total complex gain, for a given frequency f, is modelled as
G(f)=1−Rfc_{surf}e^{2πifΔt}^{_{sg}}−Rfc_{surf}e^{2πifΔt}^{_{rg}}+Rfc_{surf}²e^{2πifΔt}^{_{2g}}
where Rfc_{surf} is the modelled sea surface reflectivity (positive), and Δt_{sg}, Δt_{rg} and Δt_{2g} are the time lags between the primary reflection and the source, receiver and double ghost reflections respectively, that is,
Δt_{sg}=t(_{sg})−t
Δt_{rg}=t(_{rg})−t
Δt_{2g}=t(_{2g})−t.

9. A method of spectrum restoring and broadening as defined in claim 1, wherein each shot record is divided into a plurality of windows using a radial trace architecture.

10. A method of spectrum restoring and broadening as defined in claim 9, wherein the step of dividing each shot record into a plurality of windows using a radial trace architecture involves limiting the span of the design windows to deliver localisation in receiver depth, in incident angle, in Two Way Time (TWT), and localisation in source depth and sea state by having each window span shot records that are most similar in source depth and receiver depth.

11. A method of spectrum restoring and broadening as defined in claim 10, wherein all shots within the survey are initially binned into groups based on these parameters to ensure localisation of parameters between shots in the windows.

12. A method of spectrum restoring and broadening as defined in claim 11, wherein the radial trace architecture can be used in two different ways, both of which produce substantially the same outcome.

13. A method of spectrum restoring and broadening as defined in claim 12, wherein a full radial trace transform is applied whereby the shot record (TWT vs offset) is remapped onto radial traces (TWT vs angle).

14. A method of spectrum restoring and broadening as defined in claim 12, wherein design windows are constructed from trace segments that form a patch along radial trace trajectories.

15. A method of spectrum restoring and broadening as defined in claim 5, wherein following optimisation a set of fitted parameters exist for every trace segment, which can then be used to design an inverse filter to correct the distortion caused by the ghost reflections.

16. A method of spectrum restoring and broadening as defined in claim 15, wherein these fitted parameters are then further constrained with respect to the expected variability both within a shot and between shots.

17. A method of spectrum restoring and broadening as defined in claim 16, wherein an inverse filter is achieved by correcting the amplitudes and phases separately.

18. A method of spectrum restoring and broadening as defined in claim 1, wherein the shot records are obtained from a marine seismic survey in which one or more streamers are towed behind a boat, and a seismic source which is also towed directly behind the boat, the seismic source creating an acoustic signal (seismic wave field) that propagates through the water column and into the geological strata beneath.

19. A method of spectrum restoring and broadening as defined in claim 18, wherein each streamer is a long cable containing a plurality of acoustic receivers (measuring pressure and/or velocity of the seismic wave field) spaced regularly along its length, and the seismic source is an air gun array.

20. A method of spectrum restoring and broadening as defined in claim 19, wherein there are three types of ghost reflection, the source ghost, the receiver ghost and the double ghost, the deleterious effects of which in the shot records can be substantially eliminated; wherein the source ghost travels upward directly from the seismic source, is reflected at the sea surface and then goes on to be reflected off the rock strata and recorded by the acoustic receivers, and the receiver ghost travels upward after being reflected of the rock strata and is reflected off the sea surface before being recorded by the acoustic receivers, and the double ghost travels upward directly from the seismic source, is reflected at the sea surface, travels upward after being reflected of the rock strata and is reflected off the sea surface for a second time before being recorded by the acoustic receivers.
